(19) United States
(12) Patent Application Publication
(10) Pub. No.: US 2021/0048683 A1
(43) Pub. Date: Feb. 18, 2021

(54) APPARATUS AND METHOD FOR COMBINING TWO IMAGE SOURCES

(71) Applicant: INTERESTING AV LIMITED, Olney, Buckinghamshire (GB)

(72) Inventor: Richard Paul Wood, Olney, Buckinghamshire (GB)

(21) Appl. No.: 16/966,917

(22) PCT Filed: Feb. 4, 2019
(86) PCT No.: PCT/GB2019/050297

§ 371 Date: Aug. 3, 2020

(30) Foreign Application Priority Data
Feb. 2, 2018 (GB) 1801762.4

(51) Int. Cl. G02B 30/52; G03B 21/60; A63J 21/00

(52) U.S. Cl. CPC G02B 30/52; A63J 21/00; G03B 21/60

(57) ABSTRACT

Apparatus comprising a first image projecting device for projecting a first image, an optical arrangement located optically downstream of the first image projecting device such that the first image appears to a viewer, to be located on an opposite side of the optical arrangement to said first image projecting device, forwardly of the apparatus at a first image plane, the apparatus further comprising a secondary image and an at least partially transparent screen or surface, the second screen or surface positioned on the same side of the optical arrangement as the viewer and is for displaying the secondary image on the screen which appears to the viewer to be located behind the first image plane.

This invention relates to the projection of virtual or real images.

This invention produces highly effective holographic illusions that have some of the benefits of images considered to be true holograms, a popular conception of a true hologram being, for example, the concepts from popular media such as in the Star Wars movie where an image of Princess Leia is projected from R2D2.

A true hologram is created by using a two-step process by which (1) an object illuminated by coherent light is made to produce interference fringes in a photosensitive medium, such as a photographic emulsion, and (2) re-illumination of the developed interference pattern by light of the same wavelength to produce a three-dimensional image of the original object. The viewed images seen by this process have the appearance of the original object, including the differences in perspective one obtains with a change of the viewer's observing position. True holograms are not moving images and are more like photographs than movies. To develop motion, one could present a series of these hologram frames to the viewer at a rate of 25 per second and if correctly registered, and also lit from the right angle, the viewer would be able to see a true hologram effect that would mean that a moving 3-dimensional object or living creature could be captured on a 2-dimensional plane. Put simply, if you stopped the motion in such an imaginary device and then moved the viewing angle from left to right, or up then down for example, then the image in the stopped frame would still look 3-dimensional. Such a device is likely to be very expensive in current day terms. The content production end of the holograms is also limited by speed of capture issues. Whilst stop motion techniques for content capture are possible, the best result would be achieved by a real-time capture and recording device.

In contrast, there are other commonly used techniques to fake a moving hologram using moving 2-dimensional computer-generated animation or filmed images that have been made to enhance 3-dimensional cues and then are presented in association with transparent surfaces within a volume or stage setting; examples of these techniques being direct projection onto a scrim or gauze, or the reflective Peppers ghost techniques.

To enhance these illusions, the subject content can be made to continually turn so that the viewer observes different sides of the same object and thus conveys a sense of internal object parallax as well as the parallax owing to the virtual image plane set in the middle of a volume or stage.

Traditionally, the content is created with one view point in mind and maintaining motion of the subject means that several clustered viewpoints associated with an actual vanishing point used to create the content still work.

The content for these devices is relatively easy to produce, and the data involves only 2-pixel coordinates rather than 3-voxel coordinates, and hence from a digital data point of view the content is relatively efficient to process and navigate compared to a single frame of a “true hologram” which has a full set of x, y and z coordinates to capture.

There is a compromise situation where several anamorphic perspectives are captured and, as with the production of content in Peppers ghost and similar techniques, each of these anamorphic perspectives is acceptable for clustered viewing positions. Capturing multiple perspectives and associated vanishing points for the same moment in time by, for example, having cameras set in an arc around the subject means that content can be produced for several viewing vectors, again, in an arc, but this time around the virtual image of the subject which can mean that the viewer's position can have the correct associated perspective and vanishing point presented. Of course, to present all the possible viewing perspectives at once on the same screen would result in a confused and overlaid mess of images which can only be made sense of by, for instance, separating the content for the different viewing positions on an arc. This can be done either by some form of screen which keeps the orientation of the output light to its original source direction/vector as with a lightfield display; or else separating temporally the presentation of the different perspectives, for example by sequencing the images and shuttering from the viewer data from angles that do not associate with the particular viewing vector and perspective, this being achieved by use of high frame rate displays and associated eyewear for the viewer.

According to a first aspect of the present invention, there is provided apparatus comprising a first image projecting device for projecting a first image, an optical arrangement located optically downstream of the first image projecting device such that the first image appears to a viewer, to be located on an opposite side of the optical arrangement to said first image projecting device, forwardly of the apparatus at a first image plane, the apparatus further comprising a second image projecting device and an at least partially transparent screen or surface, the second screen or surface positioned on the same side of the optical arrangement as the viewer and is for displaying a second image on the screen which appears to the viewer to be located behind the first image plane.

According to a second aspect of the present invention, there is provided a method comprising projecting a first image from a first image projecting device towards an optical arrangement, the first image appearing to a viewer, to be located on an opposite side of the optical arrangement to said first image projecting device, to be located forwardly of the optical arrangement in a first image plane, the method further comprising projecting a second image from a second image projecting device onto an at least partially transparent screen or surface positioned on the same side of the optical arrangement as the viewer for displaying the second image on the screen or surface, the second image appearing to the viewer to be located behind the first image plane.

According to a third aspect of the present invention, there is provided apparatus comprising a first image projecting device for projecting a first image, a first at least partially reflective and partially transparent screen or surface arranged obliquely to said first image projecting device, a curved reflective surface arranged to reflect the first image received from the first screen or surface back toward the first screen or surface such that the first image appears to a viewer, to be located on an opposite side of the first screen to said curved reflective surface, forwardly of the apparatus at a first image plane, the apparatus further comprising a second image projecting device and a second at least partially transparent screen or surface, the second screen or surface positioned on the same side of the first screen as the viewer and for displaying a second image on the second screen which appears to the viewer to be located behind the first image plane.

According to a fourth aspect of the present invention, there is provided a method comprising projecting a first image from a first image projecting device on to a first at least partially reflective and partially transparent screen or surface arranged obliquely to the first image projecting device, the first image being partially reflected by the first screen towards a curved reflective surface which further reflects the first image back toward the first screen or surface in such a way that the first image appears to a viewer, to be located on an opposite side of the first screen or surface to said curved reflective surface, to be located forwardly of the first screen or surface in a first image plane, the method further comprising projecting a second image from a second image projecting device onto a second at least partially transparent screen or surface positioned on the same side of the first screen or surface as the viewer for displaying the second image on the second screen or surface, the second image appearing to the viewer to be located behind the first image plane.

Owing to these aspects, an apparent holographic image can be displayed in which the first image appears to a viewer to be located in front of the second image, which allows for a wide variety of interactivity between the two images. Parallax is developed between the two images further enhancing the impression of a floating forward image.

Advantageously, the first at least partially reflective screen is a transparent screen with an at least partially reflective inner surface facing the curved reflective surface. In addition, the second at least partially reflective surface is a semi-transparent projection surface. Moreover, the curved reflective surface is preferably a mirrored surface.

The curved reflective surface is preferably curved in more than one plane.

According to a third aspect of the present invention, there is provided apparatus comprising an image projecting array, an at least partially reflective screen arranged to reflect an image projected from the image projecting array to a curved reflective surface arranged to reflect the image such that the image appears to a viewer, located on an opposite side of the first screen to said curved reflective surface, forwardly of the apparatus, wherein the image projecting array is a lightfield array including a plurality of image projection devices, each arranged to project the image of an object from different viewpoints and wherein an auto-multiscopic display is located between the image projecting array and the at least partially reflective screen, the arrangement being such that the auto-multiscopic display presents the viewer with the image of the object from the respective different viewpoints as the viewer moves in relation to the apparatus.

According to this aspect, an auto-multiscopic display is able to show a wide depth of field for horizontal and vertical parallax effects.

In order that the present invention can be clearly and completely disclosed, reference will now be made to the accompanying drawings, in which:—

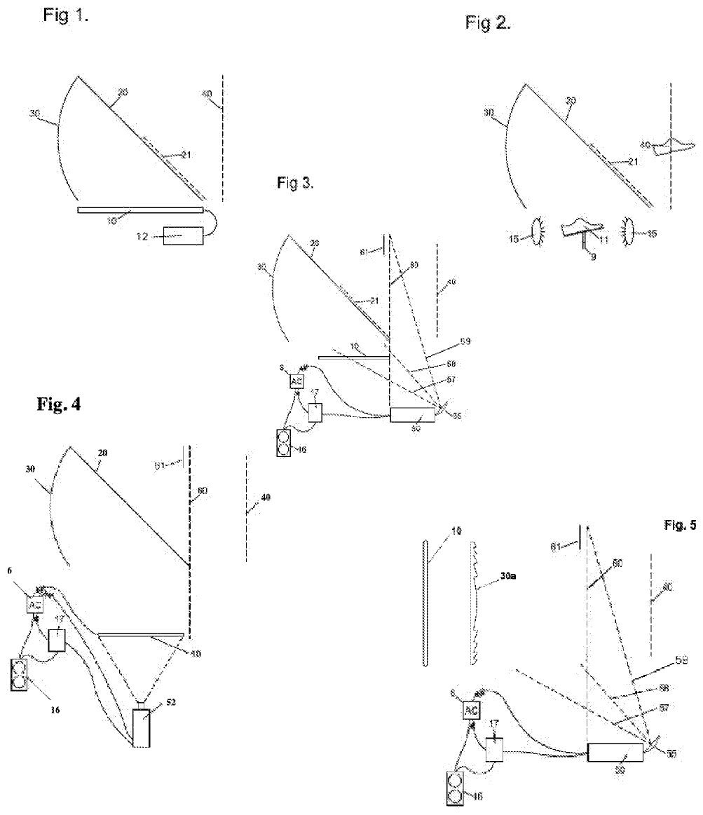

FIG. 1 is a side view of a known apparatus for projecting a single holographic image,

FIG. 2 is a side view of a known alternative arrangement of the apparatus of FIG. 1,

FIG. 3 is side view of an embodiment of a projection apparatus according to the present invention for projecting first and second images,

FIG. 4 is a side view of an alternative embodiment of the present invention,

FIG. 5 is a view similar to FIG. 4, but of an alternative arrangement,

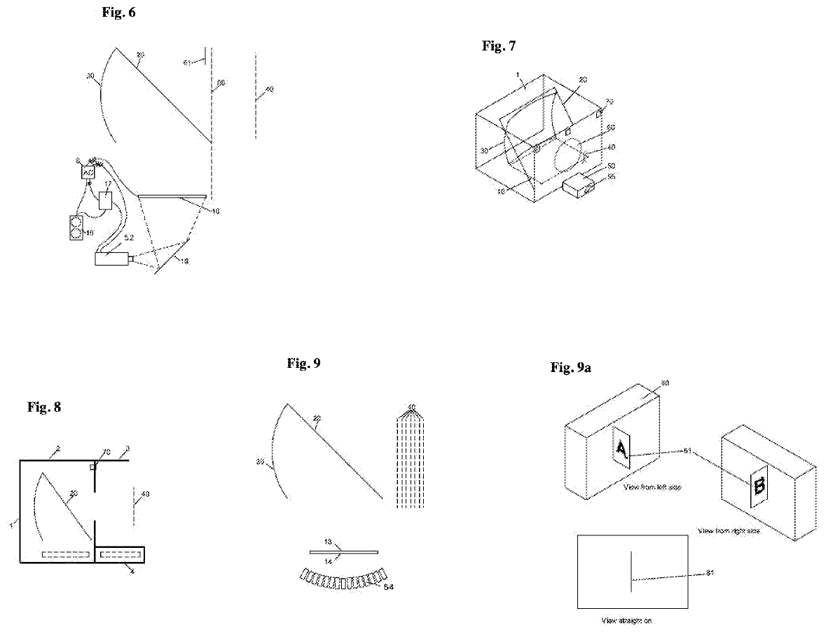

FIG. 6 is a perspective view in more detail of the apparatus of FIG. 3,

FIG. 7 is a side view of the apparatus in FIG. 6,

FIG. 8 is a side view of an apparatus for projecting an auto-multiscopic 3-dimensional display,

FIG. 8a shows, diagrammatically, images projected from the apparatus of FIG. 8a,

FIG. 9 is a view similar to FIG. 7, but with the apparatus inverted,

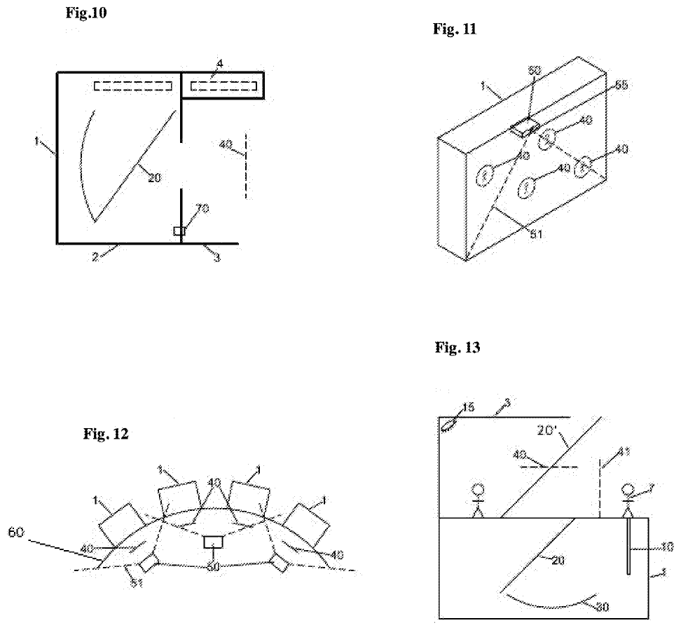

FIG. 10 is a diagrammatic perspective view of an apparatus similar to that of FIG. 6, but for projecting a plurality of first images,

FIG. 11 is a diagrammatic plan view of an arrangement wherein a screen on which the second image is projected is curved and a plurality of image projection devices project the second image in an overlapping manner, and

FIG. 12 shows an arrangement where an image that is seen by the viewer as created by the apparatus of FIG. 1 is reflected in a ‘Peppers ghost’ arrangement.

Referring to FIG. 1, a known image projection device includes a curved, concave, mirrored surface 30 arranged in such an orientation that it is aligned relative to an at least partially transparent and at least partially reflecting inner surface of a planar screen or surface 20 which may be made of glass or plastics material, for example polyethylene terephthalate (PET). The audience facing side of the screen 20 may include a dark sometimes polarising film or surface treatment 21 in order to reduce excess glare from a projected image. This arrangement produces a vertically aligned apparently floating image 40 which is projected forwardly of the apparatus when correctly aligned to an image projection device 10, such as an LCD device or an LCD device back-lit with LEDs or OLEDs or any other suitable electronic display or monitor capable of reproducing video imagery supplied to it from a computer or media server 12. The image plane in which the image 40 appears is sometimes optically known as the “real image” position. The use of 3-dimensional computer-generated graphic animation and/or image capture content from cameras and scanning devices renders the floating image 40 with convincing 3-dimensional visual cues. This arrangement is known to produce a realistic holographic experience for the viewer. The subject of the projected content is presented on a black background since this allows the subject to appear in isolation from the rest of this image frame against a plane background, black being the absence of light which means that it is neither reflected nor projected in the system shown.

Referring to FIG. 2, a similar arrangement to that of FIG. 1 is shown, in which the vertically aligned floating image 40 is projected forwardly of the apparatus when correctly aligned to a real physical object 11 of suitable dimensions so as to be able to be located close to a light source 15 or series of light sources that illuminate the object when located at the correct distance from the curved, concave, mirror 30 and the transparent reflecting surface 20. The object 11 is preferably mounted on or otherwise attached to a spindle 9 which is capable of rotating the object 11 such that different views of the various surfaces of the object 11 are presented to the viewer. The 3-dimensional cues presented in this way make the floating image 40 look like the real object 11.

Referring to FIG. 3, the concave mirrored surface 30 and the screen 20 are arranged similarly to that of FIGS. 1 and 2. This arrangement also produces a vertically aligned floating first image 40 which is perceived to be projected forwardly of the apparatus when correctly aligned to the first or source image projecting device 10 connected to a computer or media server 17. In this arrangement, however, the floating image 40 is set against a backdrop of a secondary projected image that is created by projecting the secondary image onto a specially selected second semi-transparent screen or surface 60. The projection surface 60 can be a made from a fine wire knit, e.g. polyester, steel or a open weave material with an effective percentage of holes, preferably but not exclusively, made from a material such as a silver-coated yarn either of a bobbinet or open knit weave that makes the material both transparent as well as able to reflect the projected light from a projector device 50. The silver coated material can also be made by a process of manufacturing a non-silvered bobbinet or knit rather than being made from silver coated yarn with the yarn previously coated before being made into a piece of material greige and heat treated and fixed with a process of silver compound application being performed either on the greige or the fixed material. A further application of a stiffening agent after or during the heat fixing process would help to reduce the amount of silver tarnishing by preventing the air from interacting with the silver compounds. Such a material and projection device combination performing an effective holographic illusion on its own without the combination of the other elements described, but with the other elements this becomes a more engaging display. A further improvement can be made by backing this partially transparent surface with a tinted but otherwise transparent glass or plastics sheet. The light emitted from the projector device 50 takes an acute angle across the projection surface 60 owing to the selection of a special geometry correcting ultra-short throw lens 55 connected to the projector device 50. The digital signal for projection of the secondary image is supplied by the media server or other computer 17. An outer structure 61, which may form part of a housing for the apparatus, prevents the projected light from the projector device 50 and ultra-short throw lens 55 combination from being directed into the area containing the concave mirror 30. The extremities of a projected light path from the projector device 50 are defined by the dotted lines 57 defining the lower extremity 57 and 59 defining the upper extremity. A geometric centre line 58 lies between the extremities 57 and 59 above which the projected light is all diverging in the same direction and below this centre line the projected light is also diverging but in the opposite direction. If the projected light from the projector device 50 is aligned appropriately, the light does not project through and directly hit the transparent partially reflecting surface of the screen 20 or the attached surface treatment 21. The two angles prescribed by the intersection of the lines 57 and 58 are equal when this condition is met. The computer 17, the projector device 50 and an associated amplifier/speaker(s) combination 16 are powered by an a/c power source 6. The arrangement of FIG. 3 produces a visually spectacular display with a perception of depth with the first image 40 appearing to float forwardly of the projection surface 60 which itself has the second image projected thereon so that the first and second images are made to complement each other and with the choice of the image content, can be made to interact with each other.

Referring to FIG. 4, the arrangement shown is set up in a similar manner to the previous Figures with the exception that the real source image 10 is made by a projector and lens combination 52. In this arrangement, which can also apply to the other arrangements described herein, the secondary image is generated by a transparent OLED, LCD, or LED screen surface. The secondary image 60 could equally be provided by the ultra-short throw lens 55 and projector device 50 combination described hereinabove with reference to FIG. 3.

Referring to FIG. 5, an alternative arrangement may be possible where the curved, concave, mirrored surface 30 and the planar screen or surface 20 are replaced with an optical arrangement located optically downstream of the image projection device 10, which arrangement preferably comprises a Fresnel lens 30a. In this instance, the first image projecting device 10 is advantageously a high brightness screen for the originating digital content and is ideally an LCD, LED, OLED screen or a projection screen which receives a projected image from a short throw projector (and even more preferably an ultra-short throw projector) arranged for front or rear projection onto the projection screen. Instead of a Fresnel lens, it may be possible to utilise a collimator device.

Referring to FIG. 6, the arrangement is similar to that of FIG. 4 but the projected light generated by the projector and lens combination 52 is “folded” to save space by the use of an optical planar surface folding mirror 18.

FIG. 7 shows the arrangement similar to that described in FIG. 3 from a different elevation and includes an enclosure 1 that hides and supports the inner components. In addition, there are a plurality of cameras 70 mounted to the front edge region of the enclosure 1. These cameras 70 supply the computer 17 (see FIG. 3) with information about a viewer located in front of the enclosure 1. Facial orientation and recognition algorithms process the camera-feed and send instructions to the computer 17 holding the display content. These instructions allow the content to be repositioned centrally as the viewer moves left or right in order to compensate for a less desirable feature of the apparatus, which is the loss of quality in the displayed first and second images, particularly the first image, when the viewer moves left or right of centre relative to the enclosure 1. At the same time, the content is arranged to rotate in the opposite direction to the way the observer moves. This active adjustment when properly set up to be proportional to the amount of movement taken allows a scanned object to be viewed in a manner that is analogous to the way the viewer would expect to see a still motion image that is a true holographic image (as described in the preamble hereinabove). In the simplest embodiment, the computer 17 would play the rotation of an object rotating left when the viewer moves right and vice versa if the viewer moves the opposite way. If the viewer stops still in one location, the image will also stop its rotation. The correction also re-centres the content with respect the viewer in real time.

FIG. 8 shows the same arrangement as described with reference to FIG. 7, but from a side elevation. The internal surface of a roof panel 2 of the enclosure 1 is advantageously coated with a light absorbing material, and most effectively a carbon nanotube surface such as Vantablack (Registered Trade Mark) but also other standard colour surfaces also work well. Moreover, a front hood 3 is used to help restrict the impact of any overhead ambient lighting affecting the clarity of the projected images. The projector device 50 and ultra-short throw lens 55 is housed within a box-like structure 4 of the enclosure 1.

The unit defined by the housing 1 allows more than one unit to be nested together. Where two units are nested, they can be arranged to display two, respective, versions of the same forwardly projected virtual image content in the respective first image planes. Such an arrangement has the advantage that the viewing angle is doubled allowing more people to experience the image display at any one time. The second real image is presented in front of the nested units. One of the two nested units may be provided with a projector for the second image from below and the other provided with a projector for the second image from above. The surface that the second projected image(s) are projected onto may be a curved surface where the images can be edge-blended to make a seamless appearance.

The content corresponding to the first image 40 is best viewed if it is produced such that the subject is isolated on a black background and if the subject is maintained in the central area of the concave mirror 30 when viewed from a central axis through the mirror 30 (this area of viewing being equated to a central square of 9 in a 3 by 3 grid). If the content breaks frame, other than for a fraction of time, then the illusion can break down.

Content can be made using CGI techniques that embed 3-dimensional visual cues in the content. Rotating objects that present all sides of the object when the system is not in the head- or eye-tracking mode also help a stationary viewer have a better, more believable visual experience.

Scanning or photographing an object or person can also be performed to generate the content. This image can then have further post production techniques applied to it to enhance the texture lighting and isolate the subject to a black background. Filming against a black background or greenscreen also helps the post-production and can even be used for generating live transmission content, thus making this device capable of undertaking teleconferencing tasks.

Motion-capture techniques can be used to drive 3-dimensional generated images, such as characters either of a person, a creature living or otherwise, or a robot. This can then allow live interactions with an audience.

An audio system is also advantageously associated with the device that can be of a directional or a standard set-up.

The nature of the system is such that the area of the projection surface 60 that is observed as being behind the first image 40 can be viewed from many angles, whereas the viewing of the first image 40, as mentioned above, can only be seen in a limited central area. This feature means that the system can be very well suited to allow certain viewers a view of both the first image 40 and the secondary image on the projection surface 60 but others only the secondary image on the projection surface 60. Such an arrangement might be useful if, for example, some viewers need to see additional information which is either irrelevant to or secret from other viewers positioned outside the that central viewing location. The first image 40 only viewable by selected viewers may be someone performing sign language for instance, or it could contain sensitive information for some eyes only.

Referring to FIGS. 9 and 9a, the secondary image and its apparatus is not shown. The curved mirrored surface 30 is arranged in such an orientation that it is aligned to the inner surface of the partially transparent and partially reflecting screen or surface 20. Held in alignment between an image projecting array 54 including a plurality of image projecting devices and the screen or surface 20 is an auto-multiscopic display surface made from layers of diffusing particles 13 and anisotropic substrates 14 which make the auto-multiscopic display surface highly directional. In this way, an image from one of the image projecting devices in the array 54 passes through the auto-multiscopic display surface with little refraction. This effect is also possible with micro-lens arrays and lenticular structures. Each image projecting device in the image projecting array 54 projects an image of an object from different viewpoints.

FIG. 9a shows the visible display elements of a lightfield display 80. A virtual image of an object created in the “lightfield” display 80 is observed by a viewer and is comprised of the images of the object from different viewpoints having respective image planes in the perceived field of view. In this example, an object in the form of a piece of card printed with an “A” on one side and a “B” on the other side is shown as an image 81. When the viewer of this display stands to the left they would see just the letter “A” (as shown in the section of this diagram labelled “view from left side”). When the same viewer moves to the right they see just the letter “B” (as shown by “View from right side”). This horizontal parallax happens with no change to the image, i.e. stopped motion in the video content results in different viewing experiences for viewers in different locations. The view straight on is also shown to highlight the point that the edge of the card would be like a thin line when viewed directly straight on. A vertical parallax effect would also be viewable in addition to the horizontal effect.

FIG. 10 is a similar arrangement to that of FIG. 8, but simply inverted to show functional equivalents are possible.

FIG. 11 shows another embodiment of the enclosure 1 with a projector device 50 and ultra-short throw lens 55 combination, which creates the second image on the semi-transparent surface 60 attached to the front of the enclosure 1, as described in relation to FIGS. 3 and 7. Internally of the enclosure 1, there are a plurality of arrangements of optical components as described in other Figures herein which all show their own respective virtual first image 40 apparently forwardly of the enclosure 1.

Referring to FIG. 12, an arrangement with a curved transparent projection surface 60 is shown, where the surface area of the curved transparent projection surface 60 is covered by a projected second image made up of a plurality of images projected from respective projector devices 50 and which have been through a projected light soft-edge blending and warping process, where the different images from the projector devices 50 overlap, to produce one seamless secondary image. Through this curved surface 60, which is transparent and yet of a structure as previously described and is therefore able to hold a resolved focused projected image, the enclosures 1 with optics described in the other Figures hereinabove project forwardly their respective virtual images 40.

FIG. 13 shows an arrangement where the virtual image 40 that is seen by the viewer in FIG. 1 is reflected in a Pepper's ghost arrangement. The result when set up correctly is such that the viewed virtual image 41 is forward of a Pepper's ghost reflecting screen 20′ arranged substantially parallely to the partially transparent and partially reflective screen or surface 20. Such a screen 20′ can be made from any suitable material, such as, for example, glass, plastics or a plastics film (e.g. a PET film) with light reflecting and transmitting properties. These surfaces can be silvered, partially silvered or un-silvered. Such silvering refers to a treatment that causes more solid vibrant reflections and does not necessarily involve the use of actual silver (other metal compounds such as aluminium and magnesium can be used to improve the reflectivity of these screen materials). A degree of transparency is naturally preferential in these Pepper's ghost systems and the level of lighting in the space behind the reflecting screen 20′ should be adjusted to compensate for any reduction in the transparency caused by the addition of any reflecting treatments applied to the screen 20′. Sometimes, thicker screens 20′ have an anti-reflection coating on one of its major surfaces to overcome any secondary reflections, particularly but not exclusively from the rear surface of the reflecting material; this is less important when the two major surfaces of the reflecting screen 20′ are close together, for example about 0.7 mm or less.

Adjustment of the position of the lower optics 10, 20, 30 in the housing 1 relative to the Pepper's ghost reflecting screen 20′ can cause the virtual position of the viewed image 41 to move backwards or forwards through the reflecting 20′ surface.

A similar arrangement can be set up where the reflecting screen 20′ is substantially vertical and the image from the optical arrangement as in FIG. 1 is actually pointing away from the viewer and hidden by a physical structure, the image only viewed as a reflection. This arrangement can be changed such that the viewed virtual image 41 can be seen in front of or behind the reflecting screen 20′. In other words, the angle of the optical components 10, 20, 30 can change to be other than the 45 degree Peppers ghost reflection as shown. In this way, it is possible to tilt the optical components 10, 20, 30 so that the concave mirror 30 is not facing directly upwardly but instead facing more towards to the back wall. In such a circumstance, the viewer would be looking over the structure 1 and down into an arrangement that has the screen 20′ repositioned in an appropriate manner to compensate for the change in the optical components 10, 20, 30.

The floor of the stage forward of the screen 20′ where an actor or presenter 7 may be positioned could be made from a transparent surface and in some instances when the viewer's direct sight of the stage floor in this area is obscured it is possible to also project a secondary image (not shown) that will be observed by the rules of an ordinary peppers ghost system to the rear of the screen 20′ and thus further developing the visual impact.

Any of the curved reflecting surfaces mentioned above can also be made from a black mirrored surface, i.e. a highly reflective front surface which also has a black matrix structure, such as a black polyester surface. The reflective properties are very specular in nature due to the surface bonding but when there is no reflection happening, the surface is black which is preferential for conveying solid images in which it is not possible to project or reflect black. Black being substituted by the mind's eye at the correct surface position for the image rather than perceived as only at the background.

Furthermore, the projection of an image is also possible with the use of metamaterials capable of replicating optical refractions that occur in nature as well as these that do not appear in nature, e.g. negative refractive indexes. This means that such projection devices provided with metamaterials will out-perform existing arrangements. The nano structure of metamaterials can be arranged to replicate collimating elements. Moreover, when attaching metamaterials to micromirror DMD (Digital Micromirror Device) type chipsets, small scale units can be developed that use the fast movement cycle time of the micro mirrors, e.g. up to 120 Hz, whereby such an arrangement allows for more than one virtual image position to be produced at the same time by the same image source. As such, display units could be replicated at a small, i.e. hand held, size.

A further aspect of the present invention is the use of a printed but transparent surface as the secondary image. This produces a background for the projected first image to appear in front of, hence improving the experience of parallax. These surfaces can be printed open weave surfaces or more solid transparent surfaces with small enough holes to allow the first image to be viewed and not obscured.

1. Apparatus comprising an image projecting device for projecting a first image, an optical arrangement located optically downstream of the image projecting device such that a first image appears to a viewer, to be located on an opposite side of the optical arrangement to said image projecting device, forwardly of the apparatus at a first image plane, the apparatus further comprising a secondary image projecting device and an at least partially transparent screen or surface, the screen or surface positioned on the same side of the optical arrangement as the viewer and is for displaying the secondary image on the screen or surface which appears to the viewer to be located behind the first image plane.

2. (canceled)

3. (canceled)

4. A method comprising:
projecting a first image from an image projecting device towards an optical arrangement, the first image appearing to a viewer, to be located on an opposite side of the optical arrangement to said image projecting device, to be located forwardly of the optical arrangement in a first image plane, the method further comprising providing a secondary image on an at least partially transparent screen or surface positioned on the same side of the optical arrangement as the viewer for displaying the secondary image on the screen or surface, the secondary image appearing to the viewer to be located behind the first image plane.

5. (canceled)

6. (canceled)

7. (canceled)

8. (canceled)

9. (canceled)

10. (canceled)

11. Apparatus according to claim 1, wherein the at least partially transparent screen or surface is formed from a silver-coated yarn material.

12. Apparatus according to claim 1, wherein the at least partially transparent screen or surface is formed from a silver coated screen or surface.

13. (canceled)

14. (canceled)

15. Apparatus according to claim 1, and further comprising a tinted but otherwise transparent glass or plastic sheet as a backing to the at least partially transparent screen or surface for displaying the secondary image.

16. (canceled)

17. Apparatus according to claim 1, and further comprising a housing and a plurality of cameras mounted to a front edge region of the housing, the cameras arranged to supply a computer with information about a viewer located in front of the enclosure whereby facial orientation and recognition algorithms process the information and send instructions to the computer which holds projected content.

18. (canceled)

19. (canceled)

20. (canceled)

21. (canceled)

22. (canceled)

23. Apparatus comprising an image projecting array, an at least partially reflective screen arranged to reflect an image projected from the image projecting array to a curved reflective surface arranged to reflect the image such that the image appears to a viewer, located on an opposite side of the first screen to said curved reflective surface, forwardly of the apparatus, wherein the image projecting array is a lightfield array including a plurality of image projection devices, each arranged to project the image of an object from different viewpoints and wherein an auto-multiscopic display is located between the image projecting array and the at least partially reflective screen, the arrangement being such that the auto-multiscopic display presents the viewer with the image of the object from the respective different viewpoints as the viewer moves in relation to the apparatus.

24. Apparatus according to claim 17, wherein the auto-multiscopic display is made from layers of diffusing particles and anisotropic substrates.

25. Apparatus according to claim 17, wherein each image projecting device in the image projecting array projects an image of an object from the different viewpoints.

26. Apparatus according to claim 1, wherein the image projecting device comprises an ultra-short throw lens.

27. Apparatus according to claim 1, wherein the screen or surface is a transparent OLED, LCD or LED screen or surface.

28. Apparatus according to claim 1, and further comprising a housing defining a projection unit having first and second units, wherein the first and second units are nestable together, the arrangement being such that first and second respective first images are displayed in the respective first image planes.

29. Apparatus according to claim 1, wherein the first image content is motion-capture driven.

30. Apparatus according to claim 1, and further comprising a directional audio system.

31. Apparatus according to claim 1, wherein the optical arrangement includes an at least partially reflective and partially transparent screen or surface arranged obliquely to said first image projecting device and a curved reflective surface, wherein the curved reflective surface is a black mirrored surface.

32. Apparatus according to claim 1, and further comprising metamaterials for the display of images.

33. Apparatus according to claim 32, wherein the metamaterials are attached to a digital micromirror device chipset.

34. Apparatus according to claim 1, wherein the first image is reflected in a Pepper's ghost arrangement.
